(19) United States
(12) Patent Application Publication
(10) Pub. No.: US 2025/0046222 A1
(43) Pub. Date: Feb. 6, 2025

(54) DISPLAY DEVICE AND CONTROL METHOD THEREFOR

(71) Applicant: LG ELECTRONICS INC., Seoul (KR)

(72) Inventors: Jiwon DO, Seoul (KR); Jaekyung LEE, Seoul (KR)

(73) Assignee: LG ELECTRONICS INC., Seoul (KR)

(21) Appl. No.: 18/697,368

(22) PCT Filed: Oct. 8, 2021
(86) PCT No.: PCT/KR2021/013924

§ 371 Date: Mar. 29, 2024

(51) Int. Cl. G09G 3/00

(52) U.S. Cl. CPC G09G 3/035; G09G 2330/023; G09G 2340/0435; G09G 2340/045; G09G 2354/00

(57) ABSTRACT

One embodiment of the present disclosure provides a display device comprising: a display including a display area for outputting content; a memory for storing at least one piece of data; a motor for controlling a partial area of the display area so as to be exposed; and a control unit for controlling the display, the memory, and the motor. The control unit: in a state in which only the partial area of the display area is exposed, outputs the content on a first area of the partial area; in a state in which the content is output on the first area, receives a first control signal; and outputs an OSD menu on at least one of the first area and a second area of the partial area.

### TECHNICAL FIELD

The technical field of the present disclosure is a variety of multimedia devices with a display. More particularly, the present disclosure relates to a display device in which the size of an exposed display is varied.

### BACKGROUND

A display device is a device having a function of receiving, processing, and displaying an image to be viewed by a user. For example, the display device receives a broadcast selected by the user from among broadcast signals transmitted from a broadcasting station, separates an image signal from the received signal, and displays the separated image signal on the display.

Recently, due to the development of broadcasting technologies and network technologies, the functions of the display device have been significantly diversified, and the performance of the device has been improved accordingly. That is, the display device has been developed to provide not only content to be broadcast but also other various contents to the user. For example, the display device may provide game play, music appreciation, internet shopping, user customized information, and the like using various applications as well as programs received from a broadcasting station. To perform such an extended function, the display device may basically be connected to other devices or networks by using various communication protocols, and may provide a user with a ubiquitous computing environment. That is, the display device is advanced to a smart device that enables connectivity and commercial computing to the network.

In the display device according to the related art, all regions of the display are always exposed. However, when a black screen is always exposed even when a user does not watch the display device, the user may not sufficiently utilize a space. There is no service for utilizing only a partial region of a display of a display device as a display.

That is, in a state in which only a partial region of the display device is exposed to the outside, when all of the entire screen and an on screen display (OSD) menu of the content are displayed in a content region of the partial region, the size of the OSD menu is reduced, thereby causing a problem of degraded visibility.

To resolve this, in a state in which only a partial region of the display device is exposed to the outside, it is necessary to enlarge and output the OSD menu in an OSD region of a partial region of the display region.

### DISCLOSURE

### Technical Problem

An embodiment of the present disclosure is to provide a system for selectively exposing a partial region or an entire region of a display by using a motor or the like added to the display device.

Another embodiment of the present disclosure is to specifically define content displayed on a partial region or an entire region of a display to minimize power consumption such as a motor added to a display device. With a motor operation, it is very important to define specific content displayed in a specific mode as much power consumption is expected compared to a conventional display device.

### Technical Solution

According to an embodiment of the present disclosure, a method of controlling a display device in which a size of an exposed display region is changed includes outputting content in a first region of a partial region of the display region in a state in which only the partial region of the display region is exposed, receiving a first control signal in a state in which content is output in the first region, and outputting an on screen display (OSD) menu in at least one of the first region and a second region of the partial region.

The method may further include, based on the OSD menu being output in the first region, outputting the OSD menu and the content together.

The method may further include, based on the OSD menu being output in both the first region and the second region, equally applying an input signal for the OSD menu to the first region and the second region.

The method may further include, based on the content and the OSD menu being simultaneously output in the first region, scaling an image signal corresponding to the content and the OSD menu based on a size of the partial region of the display region.

Based on the OSD menu being output in the second region, a vertical size of the OSD menu output in the second region may be equal to a vertical size at a time of outputting the OSD menu in an entire region of the display region, and a horizontal size of the OSD menu output in the second region may be equal to a vertical size of the second region.

The method may further include, based on the OSD menu being output in the second region, descaling a size of the OSD menu output in an entire region of the display region based on a horizontal size of the second region, cropping the size of the OSD menu based on a vertical size of the second region, and outputting the OSD menu in the second region.

The method may further include, based on receiving of a second control signal in a state in which the OSD menu is currently output, scrolling and outputting the OSD menu based on a moving path of the second control signal.

The method may further include, based on receiving of an input signal of selecting a first menu of the OSD menu in a state in which the OSD menu is currently output, outputting content corresponding to the first menu in the first region.

The method may further include, based on receiving of an input signal of selecting a second menu of the OSD menu in a state in which the OSD menu is currently output, controlling a motor to expose an entire region of the display region, and outputting content corresponding to the second menu in the entire region.

The method may further include, in a state in which the OSD menu is currently output in the first region, recognizing a focus for a third menu of the OSD menu, and enlarging and outputting the third menu in the second region based on the focus.

Content displayed in the first region may be content displayed immediately before the display device is turned off.

According to an embodiment of the present disclosure, a display device includes a display including a display region in which content is output, a memory configured to store at least one data, a motor controlled to expose a partial region of the display region, and a controller configured to control the display, the memory, and the motor, wherein the controller is configured to output content in a first region of the partial region in a state in which only the partial region of the display region is exposed, a first control signal is received in a state in which content is output in the first region, and an on screen display (OSD) menu is output in at least one of the first region and a second region of the partial region.

Based on the OSD menu being output in both the first region and the second region, the controller may equally apply an input signal for the OSD menu to the first region and the second region.

Based on the content and the OSD menu being simultaneously output in the first region, the controller may scale an image signal corresponding to the content and the OSD menu based on a size of the partial region of the display region.

Based on the OSD menu being output in the second region, a vertical size of the OSD menu output in the second region may be equal to a vertical size at a time of outputting the OSD menu in an entire region of the display region, and a horizontal size of the OSD menu output in the second region is equal to a vertical size of the second region.

Based on the OSD menu being output in the second region, the controller may be configured to descale a size of the OSD menu output in an entire region of the display region based on a horizontal size of the second region, crops the size of the OSD menu based on a vertical size of the second region, and outputs the OSD menu in the second region.

Based on receiving of a second control signal in a state in which the OSD menu is currently output, the controller may be configured to scroll and output the OSD menu based on a moving path of the second control signal.

based on receiving of an input signal of selecting a first menu of the OSD menu in a state in which the OSD menu is currently output, the controller may be configured to output content corresponding to the first menu in the first region.

based on receiving of an input signal of selecting a second menu of the OSD menu in a state in which the OSD menu is currently output, the controller may be configured to control a motor to expose an entire region of the display region and output content corresponding to the second menu in the entire region.

In a state in which the OSD menu is currently output in the first region, the controller may be configured to recognize a focus for a third menu of the OSD menu and enlarge and output the third menu in the second region based on the focus.

### Advantageous Effects

According to an embodiment of the present disclosure, a system for selectively exposing a partial region or an entire region of a display by using a motor or the like added to the display device is provided.

According to another embodiment of the present disclosure, it is possible to minimize unnecessary power consumption such as a motor of a display device by specifically defining content displayed according to an exposed display size.

According to another embodiment of the present disclosure, there is an advantage in that an on screen display (OSD) menu provided in an entire region is to be used without change in a partial region.

### BRIEF DESCRIPTION OF THE DRAWINGS

FIG. 1 is a diagram illustrating components in a display device according to an embodiment of the present disclosure.

FIG. 2 is a diagram for explaining components of a controller of a display device according to an embodiment of the present disclosure.

FIG. 3 is a diagram illustrating an operation of a display device according to an embodiment of the present disclosure.

FIG. 4 is a diagram illustrating an operation of a display device according to another embodiment of the present disclosure.

FIG. 6 is a diagram for explaining a motor for adjusting a size of an exposed display region of a display device according to an embodiment of the present disclosure.

FIG. 7 is a diagram for explaining an embodiment in which a display of a display device outputs content in a partial region according to an embodiment of the present disclosure.

FIGS. 8A and 8B are diagrams for explaining an embodiment in which content output to an entire region of a display of a display device is output in a partial region according to an embodiment of the present disclosure.

FIGS. 9A and 9B are diagrams for explaining an embodiment in which an on screen display (OSD) menu output from an entire region of a display of a display device is output in a partial region according to an embodiment of the present disclosure.

FIG. 10 is a diagram for explaining an embodiment of calculating coordinates when a display device selects an OSD menu according to an embodiment of the present disclosure.

FIGS. 11A and 11B are diagrams for explaining an embodiment of selecting an OSD menu in a display device according to an embodiment of the present disclosure.

FIG. 12 is a diagram for explaining an embodiment of controlling an OSD menu in a display device according to an embodiment of the present disclosure.

FIG. 13 is a flowchart illustrating a method of controlling a display device according to an embodiment of the present disclosure.

### BEST MODE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

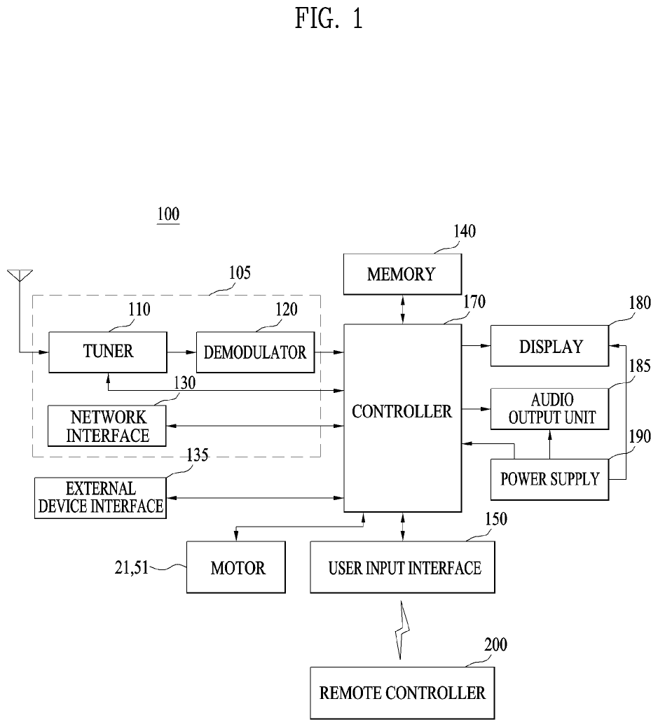

FIG. 1 is a diagram illustrating components in a display device according to an embodiment of the present disclosure.

Referring to FIG. 1, a display device 100 may include a broadcast receiver 105, an external device interface 135, a memory 140, a user input interface 150, a controller 170, a display 180, an audio output unit 185, and a power supply 190. The components illustrated in FIG. 1 are not indispensable for implementing the display device 100, and thus the device 100 described in the specification may have more or fewer components than those listed above.

The aforementioned components are not shown in detail in the accompanying drawings, and only some important components may be illustrated in the accompanying drawings. However, although not all shown, one of ordinary skill in the art will appreciate that at least the components of FIG. 1 may be included in the display device 100 to implement functionality as a display device.

The broadcasting receiver 105 may include a tuner 110, a demodulator 120 and a network interface 130. As needed, the broadcasting receiver 105 may be configured to include only the tuner 110 and the demodulator 120 or only the network interface 130.

The tuner 110 tunes to a Radio Frequency (RF) broadcast signal corresponding to a channel selected by a user from among a plurality of RF broadcast signals received through an antenna and downconverts the tuned RF broadcast signal into a digital Intermediate Frequency (IF) signal or an analog baseband video or audio signal. More specifically, if the tuned RF broadcast signal is a digital broadcast signal, the tuner 110 downconverts the tuned RF broadcast signal into a digital IF signal DIF. On the other hand, if the tuned RF broadcast signal is an analog broadcast signal, the tuner 110 downconverts the tuned RF broadcast signal into an analog baseband video or audio signal CVBS/SIF. That is, the tuner 110 may be a hybrid tuner capable of processing not only digital broadcast signals but also analog broadcast signals. The analog baseband video or audio signal CVBS/SIF may be directly input to the controller 170. The tuner 110 may be capable of receiving RF broadcast signals from an Advanced Television Systems Committee (ATSC) single-carrier system or from a Digital Video Broadcasting (DVB) multi-carrier system. The tuner 110 may sequentially tune to a number of RF broadcast signals corresponding to all broadcast channels previously stored by a channel storage function from a plurality of RF signals received through the antenna and may downconvert the tuned RF broadcast signals into IF signals or baseband video or audio signals.

The demodulator 120 receives the digital IF signal DIF from the tuner 110 and demodulates the digital IF signal DIF. For example, if the digital IF signal DIF is an ATSC signal, the demodulator 120 may perform 8-Vestigal SideBand (VSB) demodulation on the digital IF signal DIF. The demodulator 120 may also perform channel decoding. For channel decoding, the demodulator 120 may include a Trellis decoder (not shown), a de-interleaver (not shown) and a Reed-Solomon decoder (not shown) so as to perform Trellis decoding, de-interleaving and Reed-Solomon decoding. For example, if the digital IF signal DIF is a DVB signal, the demodulator 120 performs Coded Orthogonal Frequency Division Multiple Access (COFDMA) demodulation upon the digital IF signal DIF. The demodulator 120 may also perform channel decoding. For channel decoding, the demodulator 120 may include a convolution decoder (not shown), a de-interleaver (not shown), and a Reed-Solomon decoder (not shown) so as to perform convolution decoding, de-interleaving, and Reed-Solomon decoding.

The demodulator 120 may perform demodulation and channel decoding on the digital IF signal DIF, thereby obtaining a Transport Stream (TS). The TS may be a signal in which a video signal, an audio signal and a data signal are multiplexed. For example, the TS may be an MPEG-2 TS in which an MPEG-2 video signal and a Dolby AC-3 audio signal are multiplexed. An MPEG-2 TS may include a 4-byte header and a 184-byte payload. In order to properly handle not only ATSC signals but also DVB signals, the demodulator 120 may include an ATSC demodulator and a DVB demodulator. The TS output from the demodulator 120 may be input to the controller 170 and thus subjected to demultiplexing and A/V signal processing. The processed video and audio signals are output to the display 180 and the audio output unit 185, respectively.

The network interface 130 serves as an interface between the image display device 100 and a wired/wireless network such as the Internet. The network interface 130 may include an Ethernet port for connection to a wired network. For connection to wireless networks, the network interface 130 may use Wireless Local Area Network (WLAN) (i.e., Wi-Fi), Wireless Broadband (WiBro), World Interoperability for Microwave Access (WiMax), and High Speed Downlink Packet Access (HSDPA). The network interface 130 may transmit data to or receive data from another user or electronic device over a connected network or another network linked to the connected network. Especially, the network interface 130 may transmit data stored in the image display device 100 to a user or electronic device selected from among users or electronic devices pre-registered with the image display device 100. The network interface 130 may access a specific Web page over a connected network or another network linked to the connected network. That is, the network interface 130 may access a specific Web page over a network and transmit or receive data to or from a server. Additionally, the network interface 130 may receive content or data from a CP or an NP. Specifically, the network interface 130 may receive content such as movies, advertisements, games, VOD, and broadcast signals, and information related to the content from a CP or an NP. Also, the network interface 130 may receive update information about firmware from the NP and update the firmware. The network interface 130 may transmit data over the Internet or to the CP or the NP.

The network interface 130 may selectively receive a desired application among open applications over a network. In an aspect of this disclosure, when a game application is executed in the image display device, the network interface 130 may transmit data to or receive data from a user terminal connected to the image display device through a network. In addition, the network interface 130 may transmit specific data to or receive specific data from a server that records game scores.

The external device interface 135 may serve as an interface between an external device and the image display device 100. For interfacing, the external device interface 135 may include an A/V Input/Output (I/O) unit (not shown) and/or a wireless communication module (not shown). The external device interface 135 may be connected to an external device such as a Digital Versatile Disc (DVD) player, a Blu-ray player, a game console, a camera, a camcorder, or a computer (e.g., a laptop computer), wirelessly or by wire. Then, the external device interface 135 externally receives video, audio, and/or data signals from the external device and transmits the received input signals to the controller 170. In addition, the external device interface 135 may output video, audio, and data signals processed by the controller 170 to the external device. In order to receive or transmit audio, video and data signals from or to the external device, the external device interface 135 includes the A/V I/O unit (not shown) and/or the wireless communication module (not shown). The A/V I/O unit may include a Universal Serial Bus (USB) port, a Composite Video Banking Sync (CVBS) port, a Component port, a Super-video (S-video) (analog) port, a Digital Visual Interface (DVI) port, a High-Definition Multimedia Interface (HDMI) port, a Red-Green-Blue (RGB) port, and a D-sub port, in order to input the video and audio signals of the external device to the image display device 100. The wireless communication module may perform short-range wireless communication with other electronic devices. For short-range wireless communication, the wireless communication module may use Bluetooth, Radio-Frequency IDentification (RFID), Infrared Data Association (IrDA), Ultra WideBand (UWB), ZigBee, and Digital Living Network Alliance (DLNA) communication standards. The external device interface 135 may be connected to various set-top boxes through at least one of the above-described ports and may thus perform an I/O operation with the various set-top boxes. The external device interface 135 may receive applications or an application list from an adjacent external device and provide the applications or the application list to the controller 170 or the memory 140.

The external device interface 135 may establish a communication network with various remote controllers 200, receive a control signal related to an operation of the display device 100 from the remote controller 200, or transmit data related to the operation of the display device 100 to the remote controller 200.

The memory 140 may store various programs necessary for the controller 170 to process and control signals, and may also store processed video, audio and data signals. For example, the memory 140 may store application programs designed to perform various tasks to be processed by the controller 170, and may selectively provide some of the stored application programs when the controller 170 requests.

Programs stored in the memory 140 is not particularly limited as long as the programs may be executed by the controller 170. The memory 140 may temporarily store an image, a voice, or a data signal received from an external device through the network interface 130. The memory 140 may store information about a certain broadcast channel through a channel memory function such as a channel map.

The memory 140 may include at least one of a volatile memory (e.g., DRAM, SRAM, and SDRAM) or a non-volatile memory (e.g., a flash memory, a hard disk drive (HDD), and a solid state drive (SSD)).

While the memory 140 is shown in FIG. 1 as configured separately from the controller 170, to which this disclosure is not limited, the memory 140 may be incorporated into the controller 170, for example.

The user input interface 150 transmits a signal received from the user to the controller 170 or transmits a signal received from the controller 170 to the user. For example, the user input interface 150 may receive control signals such as a power-on/off signal, a channel selection signal, and a screen setting signal from a remote controller 200 or may transmit a control signal received from the controller 170 to the remote controller 200, according to various communication schemes, for example, RF communication and IR communication. For example, the user input interface 150 may provide the controller 170 with control signals received from local keys (not shown), such as inputs of a power key, a channel key, and a volume key, and setting values. Also, the user input interface 150 may transmit a control signal received from a sensor unit (not shown) for sensing a user gesture to the controller 170 or transmit a signal received from the controller 170 to the sensor unit. The sensor unit may include a touch sensor, a voice sensor, a position sensor, a motion sensor, etc.

The controller 170 typically controls the overall operation of the display device 100. The controller 170 may provide or process information or functions appropriate for a user by processing signals, data, information, and the like, which are input or output through all components illustrated in FIG. 1, or driving an application program stored in the device 100. Although not shown, the device 100 may include a substrate therein. The substrate may be a component mounted together with various electronic components, particularly, other circuits and devices that assist the various electronic components, and may be installed in a housing 10. Although not shown in detail, each of the components illustrated in FIG. 1 may be directly installed on the substrate to be controlled by the controller 170, or may be installed in the housing 10 to be electrically connected to the substrate. Accordingly, the controller 170 may be referred to as various names such as a controller and a controlling device, and may control the display device 100 and all components thereof. Accordingly, all operations and controls included in the detailed description of the present application may be considered as features of the controller 170.

The controller 170 may demultiplex the TS received from the tuner 110, the demodulator 120, or the external device interface 135 into a number of signals and process the demultiplexed signals into audio and video data. The video signal processed by the controller 170 may be displayed as an image on the display 180. The video signal processed by the controller 170 may also be transmitted to an external output device through the external device interface 135.

The audio signal processed by the controller 170 may be audibly output through the audio output unit 185. Also, the audio signal processed by the controller 170 may be transmitted to the external output device through the external device interface 135. While not shown in FIG. 1, the controller 170 may include a DEMUX and a video processor.

The controller 170 may provide overall control to the image display device 100. For example, the controller 170 may control the tuner 110 to tune to an RF broadcast signal corresponding to a user-selected channel or a pre-stored channel. The controller 170 may control the image display device 100 according to a user command received through the user input interface 150 or according to an internal program. Especially the controller 170 may access a network and download an application or application list selected by the user to the image display device 100 over the network. For example, the controller 170 controls the tuner 110 to receive a signal of a channel selected according to a specific channel selection command received through the user input interface 150 and processes a video, audio and/or data signal of the selected channel. The controller 170 outputs the processed video or audio signal along with information about the user-selected channel to the display 180 or the audio output unit 185. As another example, the controller 170 outputs a video or audio signal received from an external device such as a camera or a camcorder through the external device interface 135 to the display 180 or the audio output unit 185 according to an external device video playback command received through the external device interface 150.

The controller 170 may control the display 180 to display images. For instance, the controller 170 may control the display 180 to display a broadcast image received from the tuner 110, an externally input image received through the external device interface 135, an image received through the network interface 130, or an image stored in the memory 140. The image displayed on the display 180 may be a Two-Dimensional (2D) or Three-Dimensional (3D) still image or moving picture. The controller 170 may control content playback. The content may include any content stored in the image display device 100, received broadcast content, and externally input content. The content includes at least one of a broadcast image, an externally input image, an audio file, a still image, a Web page, or a text file.

If an application view menu item is selected, the controller 170 may control display of applications or a list of applications that are present in the image display device 100 or downloadable from an external network. The controller 170 may control installation and execution of an application downloaded from the external network along with various UIs. Also, the controller 170 may control display of an image related to the executed application on the display 180, upon user selection.

The controller 170 may perform control to search for a user terminal network-connected to an image display device through the network interface 130, output the searched list of user terminals through the display 180, and receive a selection signal of a user terminal used as a user controller from the list of the searched user terminals through the user interface 150.

The controller 170 may control the motors 21 and 51, and may also control the aforementioned operations of a roller 20, a cover 40 and a supporter 50 according to the control. The controller 170 may control expansion and contraction of the display 30 based on information related to deformation of a flexible display 30, sensed by a deformation sensor. That is, the controller 170 may control the motors 21 and 51, the roller 20, the cover 40, and the supporter 50 to expand and contract the display 30 according to the sensed information. The controller 170 may sense the size of an actual screen formed according to the winding or unwinding of the display 30 according to the information sensed by the size sensor. More specifically, the controller 170 may display information only on a screen of the display 30 actually exposed to the outside of the housing 10 by using the information of the size sensor. The controller 170 may turn off a portion of the display 30 hidden inside the housing 10. According to this control, the controller 170 may effectively reduce power consumption, and similarly, may effectively reduce heat generation.

To sense a gesture or movement of the user, as described above, a sensing unit (not shown) having at least one of a touch sensor, a voice sensor, a position sensor, and an operation sensor may be further provided in the display device 100. The sensing unit may include a camera to directly identify the movement of the user or another camera included in the home. The signal sensed by the sensing unit (not shown) may be transmitted to the controller 170, and the controller 170 may recognize a command by a gesture of the user by using the signal. The controller 170 may check whether the user approaches the display device 100 or whether the user is present at the home.

The display 180 may generate a driving signal by converting an image signal, a data signal, an on screen display (OSD) signal, and a control signal, which is processed by the controller 170, or an image signal, a data signal, and a control signal, which are received from the network interface 130. The display 180 may include a display panel including a plurality of pixels. The plurality of pixels included in the display panel may include subpixels of RGB. Alternatively, the plurality of pixels included in the display panel may include subpixels of RGBW. The display 180 may convert an image signal, a data signal, an OSD signal, and a control signal, which are processed by the controller 170, to generate a driving signal for the plurality of pixels.

The display 180 may be various types of displays such as a Plasma Display Panel (PDP), a Liquid Crystal Display (LCD), an Organic Light-Emitting Diode (OLED) display, a flexible display, and a 3D display. The 3D display 180 may be classified into glasses-free and glasses-based types.

The display 180 may also be a touchscreen that can be used not only as an output device but also as an input device.

The audio output unit 185 may receive a processed audio signal (e.g., a stereo signal, a 3.1-channel signal or a 5.1-channel signal) from the controller 170 and output the received audio signal as sound. The audio output unit 185 may employ various speaker configurations.

The power supply 190 supplies power to the image display device 100. Particularly, the power supply 190 may supply power to the controller 170 which may be implemented as a System On Chip (SOC), the display 180 for displaying an image, and the audio output unit 185 for audio output. The power supply 190 may provide power to related components including the controller 170 to automatically start the operation of the display device according to an external command and a preset condition. For supplying power, the power supply 190 may include a converter (not shown) for converting Alternating Current (AC) into Direct Current (DC). If the display 180 is configured with, for example, a liquid crystal panel having a plurality of backlight lamps, the power supply 190 may further include an inverter (not shown) capable of performing Pulse Width Modulation (PWM) for luminance change or dimming driving.

The power supply 190 receives power from the outside and distributes the power to each component. The plurality of displays 180 may include a first power supply (not shown) to supply power for driving each display panel. A second power supply (not shown) to supply power to the first power supply may be provided in a main body frame (not shown).

When a wired method is used to transmit the power from the second power supply to the first power supply, the second power supply and the first power supply may be connected to each other when the display 180 is coupled to the main body frame.

To more conveniently supply power, a wireless charging method may be used. Wireless charging may be performed in a magnetic resonance manner by overlapping a pair of coils, and a charging coil may be used as the first power supply and a transmission coil may be used as the second power supply.

When power is applied to the transmission coil located in the main body frame, a current flows through the transmission coil, forms an electromagnetic field, and supplies power to each component of the display 180 while current flows through the charging coil located in the electromagnetic field formed by the transmission coil.

The remote controller 200 transmits a user input to the user input interface 150. For transmission of user input, the remote controller 200 may use various communication techniques such as Bluetooth, RF communication, IR communication, Ultra Wideband (UWB) and ZigBee. In addition, the remote controller 200 may receive a video signal, an audio signal or a data signal from the user input interface 150 and output the received signals visually, audibly or as vibrations. For the functions described above, the remote controller 200 may include an input element such as a physical button and a touch screen.

The display device 100 may further include an image capturing unit (not shown). The image capturing unit may capture a user. The image capturing unit may be implemented by one camera, but the present disclosure is not limited thereto, and may be implemented by a plurality of cameras. The image capturing unit may be embedded in the display device 100 or separately disposed on the display 180. Image information photographed by the image capturing unit may be input to the controller 170. The controller 170 may recognize a location of the user based on the image captured by the image capturing unit. For example, the controller 170 may determine a distance (z-axis coordinate) between the user and the display device 100. The controller 170 may identify the x-axis coordinate and the y-axis coordinate in the display 180 corresponding to a user position. The controller 170 may sense a gesture of the user based on an image captured by the image capturing unit, a signal sensed by the sensor unit, or a combination thereof.

The structure of the display device 100 described above may simply control expansion and contraction of the display 30. However, to provide a more improved function, the expansion and contraction needs to be associated with a type and amount of information to be provided, which needs to be supported by appropriate control considering the structure and characteristics of the device 100. The display device 100 basically involves interaction with a user in implementing an intended function. Therefore, through optimization of various controls, the intended functional improvement may be achieved more effectively and efficiently, including improvement of user environment and user interface of the user, and furthermore, the user experience of the smart device 100, such as ease of use and convenience, may also be significantly improved.

The above-described display device 100 may be a fixed or mobile digital broadcast receiver for receiving a digital broadcast.

The block diagram of the image display device 100 illustrated in FIG. 1 is purely exemplary. Depending upon the specifications of the image display device 100 in actual implementation, the components of the image display device 100 may be combined or omitted or new components may be added.

That is, two or more components may be incorporated into one component or one component may be configured as separate components, as needed. In addition, the function of each block is described for the purpose of describing the aspect of this disclosure and thus specific operations or devices should not be construed as limiting the scope and spirit of this disclosure.

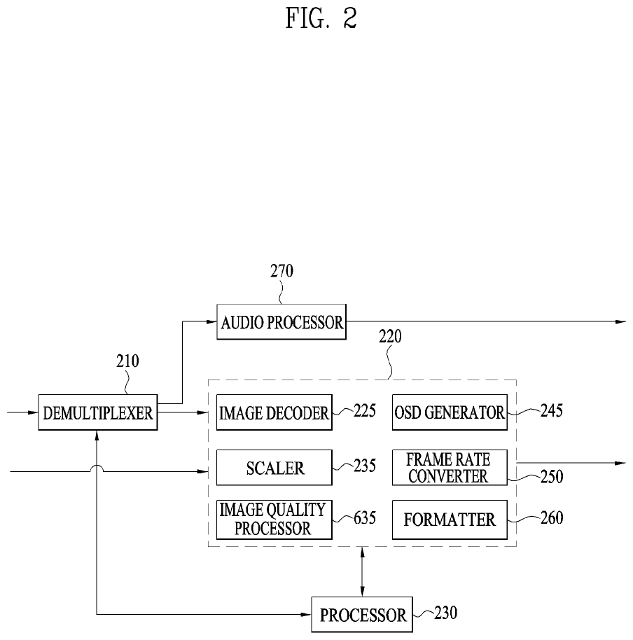

FIG. 2 is a diagram for explaining components of a controller of a display device according to an embodiment of the present disclosure.

Referring to FIG. 2, the controller 170 according to an embodiment of the present disclosure may include a demultiplexer 210, an image processor 220, a processor 230, and/or an audio processor 270. The controller 170 may further include a data processor (not shown).

The demultiplexer 210 may demultiplex an input stream. For example, when an MPEG-2 TS is input, the MPEG-2 TS may be demultiplexed into video, audio, and data signals. The stream signal input to the demultiplexer 210 may be a stream signal output from the tuner 110, the demodulator 120, or the external device interface 130.

The image processor 220 may perform signal processing on an input image. For example, the image processor 220 may perform image processing of the demultiplexed video signal from the demultiplexer 210.

To this end, the image processor 220 may include an image decoder 225, a scaler 235, an image quality processor 635, an image encoder (not shown), an OSD generator 245, a frame rate converter 250, and/or a formatter 260.

The video decoder 225 may decode the demultiplexed video signal, and the scaler 235 may perform scaling to output the resolution of the decoded video signal from the display 180.

The image decoder 225 may include decoders of various standards. For example, the image decoder 225 may include MPEG-2 and H.264 decoders, a 3D image decoder for a color image and a depth image, and a decoder for a plurality of view images.

The scaler 235 may scale an input image signal that is completely decoded by the image decoder 225. For example, when the size or resolution of the input image signal is low, the scaler 235 may up-scale the image signal and down-scale the image signal when the size or resolution of the input image signal is high.

The image quality processor 635 may perform image quality processing on an input image signal, which is completely image-decoded by the image decoder 225. For example, the image quality processor 635 may perform noise removal processing of the input image signal, expand a resolution of a grayscale of the input image signal, improve image resolution, perform high dynamic range (HDR)-based signal processing, change a frame image rate, or perform image quality processing corresponding to the characteristics of a panel, in particular, an organic light emitting panel.

The OSD generator 245 may generate an OSD signal according to a user input or autonomously. For example, based on a user input signal, a signal for displaying various types of information on a screen of the display 180 as graphic or text may be generated. The generated OSD signal may include various data such as a user interface screen, various menu screens, widgets, and icons of the image display device 100. The generated OSD signal may include a 2D object or a 3D object.

The OSD generator 245 may generate a pointer to be displayed on a display, based on a pointing signal input from the remote controller 200. In particular, the pointer may be generated by a pointing controller, and the OSD generator 245 may include the pointing controller (not shown). Needless to say, the pointing controller (not shown) may be provided separately without being provided in the OSD generator 245.

The frame rate converter (FRC) 250 may convert a frame image rate of an input image. The frame rate converter 250 may output the frame image rate without separate frame image rate conversion.

The formatter 260 may change a format of an input image signal into an image signal for displaying an image on a display and output the image signal. In particular, the formatter 260 may change the format of the image signal to correspond to the display panel.

The processor 230 may control overall operations of the image display device 100 or the controller 170. For example, the processor 230 may control the tuner 110 to tune to an RF broadcast corresponding to a channel selected by a user or a pre-stored channel.

The processor 230 may control the image display device 100 by a user command input through the user input interface 150 or an internal program. The processor 230 may perform data transmission control with the external device interface 135 or the network interface 130. The processor 230 may control operations of the demultiplexer 210 and the image processor 220 in the controller 170.

The audio processor 270 in the controller 170 may perform voice processing of the demultiplexed audio signal. To this end, the audio processor 270 may include various decoders. The audio processor 270 in the controller 170 may process a base, a treble, and volume control.

The data processor (not shown) in the controller 170 may perform data processing on the demultiplexed data signal. For example, when the demultiplexed data signal is a coded data signal, the demultiplexed data signal may be decoded. The encoded data signal may be electronic program guide information including broadcast information such as a start time and an end time of a broadcast program broadcasted in each channel.

FIG. 2 is a block diagram of the controller 170 according to an embodiment of the present disclosure. Each component of the block diagram may be integrated, added, or omitted according to the specification of the controller 170 actually implemented. In particular, the frame rate converter 250 and the formatter 260 may be separately provided in addition to the image processor 220.

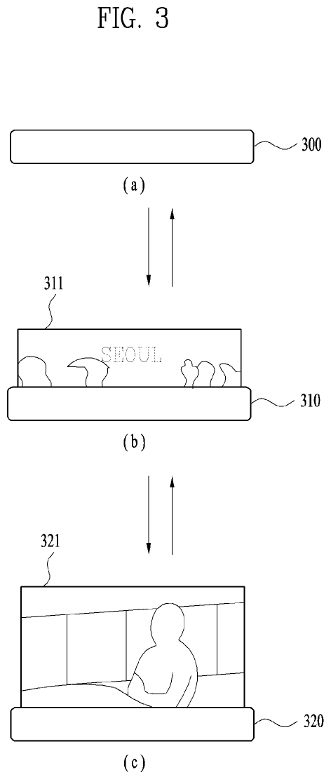

FIG. 3 is a diagram illustrating an operation of a display device according to an embodiment of the present disclosure.

Unlike the related art, the display of the display device according to an embodiment of the present disclosure may be included in the housing 300, as shown in (a) of FIG. 3. When a certain condition is satisfied (for example, when a signal pressing a power button of a remote controller once is input), as shown in (b) of FIG. 3, only a partial region 311 of the display device of the display device may be exposed from the housing 310.

When another certain condition is satisfied (for example, when a signal pressing the power button of the remote controller twice is input), as illustrated in (c) of FIG. 3, an entire region 321 of the display of the display device may be designed to be exposed from the housing 320. Needless to say, a mode in (c) of FIG. 3 may be switched to a mode in (b) and a mode in (a) in a reverse direction, and the mode in (b) may be skipped.

To implement this, the displays 311 and 321 of the display device may include a material for forming a flexible display. For example, a bendable or rollable flexible display material may be for a plastic OLED (POLED or P-OLED), and may be finished with a colorless polyimide (CPI) film, which is a plastic material. Here, the CPI film is for a transparent but rigid plastic material like glass, may freely change a shape, and may not easily break even a pressure is applied.

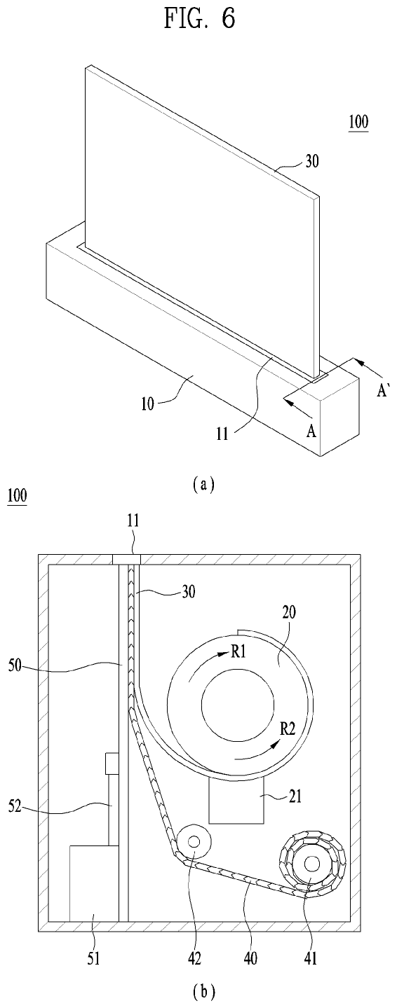

The displays 311 and 321 may be wound around rollers inside the housings 310 and 320 and then unfolded, and a motor for driving the rollers may be required. This will be described below in more detail with reference to FIG. 6.

To be distinguished from the related art, a display device designed as shown in FIG. 3 may be defined as a rollable display device or a flexible display device, a mode illustrated in (a) of FIG. 3 may be defined as a zero view, a mode illustrated in (b) of FIG. 3 may be defined as a partial view or a line view, and a mode illustrated in (c) of FIG. 3 may be defined as a full view.

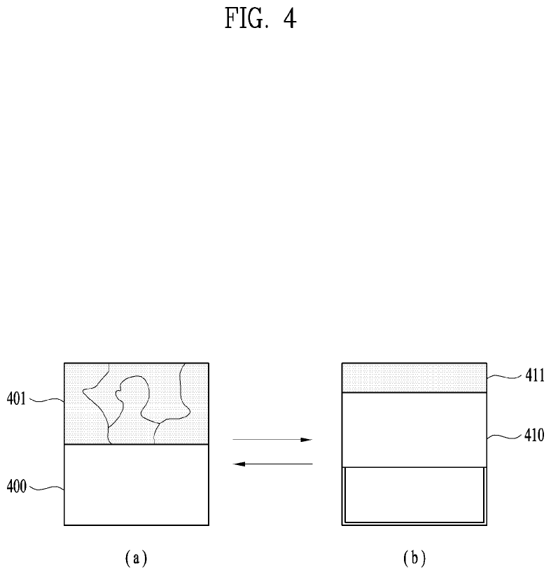

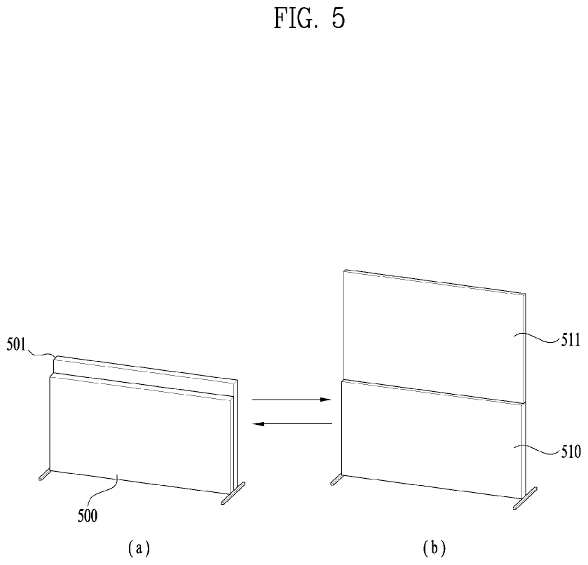

FIG. 4 is a diagram illustrating an operation of a display device according to another embodiment of the present disclosure.

Although it has been described with reference to FIG. 3 that a flexible display material is used for a display of the display device, the display device may not necessarily include a material for a flexible display, and a display of a general display device may be used without change in the embodiment of FIG. 4.

However, differently from the related art, as shown in (a) of FIG. 4, covers 400 having the same size or similar sizes may be positioned under the display 401 of the display device. When a certain condition is satisfied (for example, when a signal pressing a power button of a remote controller once is input), as shown in (b) of FIG. 4, a cover 410 may be designed to move in an up direction to expose only a partial region of a display 411 of the display device. Needless to say, a mode in (a) of FIG. 4 may be switched to a mode shown in (a) of FIG. 4. To freely move the cover shown in FIG. 4 in an up/down direction, a motor may be designed to be positioned around the cover.

To be distinguished from the related art, the display device designed as shown in FIG. 4 may be defined as an Atelier TV, a mode illustrated in (a) of FIG. 4 may be defined as a full view, and a mode illustrated in (b) of FIG. 4 may be defined as a line view or a partial view.

In an embodiment of the present disclosure, as shown in (b) of FIG. 4, the display device may define a line view state as a default mode. That is, unlike FIG. 3, the display device of FIG. 4 may have a line view state rather than a zero view as a default.

FIG. 5 is a diagram for explaining an operation of a display device according to another embodiment of the present disclosure.

Similar to FIG. 4, a material for a flexible display may not necessarily be used as a display of a display device, and a general display may be used without change. However, differently from FIG. 4, the display of the display device other than a cover itself is moved.

For example, as shown in (a) of FIG. 5, the cover 500 having the same size or similar sizes is designed to be positioned under the display 501 of the display device. A display 501 and the cover 500 of the display device may be apart from each other at a certain interval to prevent friction from being generated. When a certain condition is satisfied (for example, when a signal pressing a power button of the remote controller once is input), as illustrated in (b) of FIG. 5, the display 511 of the display device may move in an up direction to design the entire region of the display 511 of the display device to be exposed. In this case, differently from FIG. 4, a cover 510 may not move.

Needless to say, in a mode of (b) of FIG. 5 may be switched to a mode of (a) of FIG. 5. To freely move the displays 501 and 511 of the display device shown in FIG. 5 in an up/down direction, a motor may be designed around the displays 501 and 511 of the display device.

To be distinguished from the related art, a display device designed as shown in FIG. 5 may be defined as an interior TV, a mode illustrated in (a) of FIG. 5 may be defined as a partial view or a line view, and a mode illustrated in (b) of FIG. 5 may be defined as a full view.

In an embodiment of the present disclosure, as shown in (a) of FIG. 5, the display device may define a partial view state as a default mode. That is, unlike FIG. 3, the display device of FIG. 5 may have a partial view state rather than a zero view as a default.

FIG. 6 is a diagram for explaining a motor for adjusting a size of an exposed display region of a display device according to an embodiment of the present disclosure.

Although the motor is applicable to the embodiments of FIGS. 4 and 5, it is assumed that the motor is applied to the display device of FIG. 3 for convenience of description, and FIG. 6 will be described.

(a) of FIG. 6 illustrates a screen of the housing and the display device shown in FIG. 3 in a diagonal direction. (b) of FIG. 6 is a cross-sectional view taken along a line A-A′ of (a) of FIG. 6.

As shown in (a) of FIG. 6, the display device 100 may further include the housing 10.

The housing 10 may be configured to accommodate various components, and more particularly, the housing 10 may accommodate, for example, the display 30 and various electronic components for operating the display 30.

As shown in (b) of FIG. 6, the display device 100 may include the roller 20 rotatably installed in the housing 10. Although not shown, the roller 20 may include sleeves formed at both ends, and the sleeves may be rotatably supported with respect to the housing 10 by bearings.

The roller 20 may be connected to the motor 21 installed in the housing 10, and may rotate in a clockwise direction R1 or a counterclockwise direction R2 as illustrated by the motor 21. To adjust a rotation speed of the roller 20, a gear train may be located between the motor 21 and the roller 20.

The display device 100 may include the display 30 configured to display various contents and information related to the contents. For example, the display 30 may display video content, audio content, and other ancillary content. Such contents include various pieces of information associated thereto, for example, a playback time in a video content, a title of the content, and the like, and the display 30 may also display such relevant information. The display 30 may include at least one of a liquid crystal display (LCD), a thin film transistor-liquid crystal display (TFT-LCD), an organic light-emitting diode (OLED) display, a flexible display, a three-dimensional (3D) display, an e-ink display.

In detail, although not shown in detail, the display 30 may include a display module and a window covering the display module. The display module may constitute a display device such as an LCD or an OLED as described above, and may be a component that actually displays image information. The window may be located on a portion exposed to a user of the display module, that is, a front surface in terms of the drawing, and may protect the display module from the outside. In addition to such a protection function, the window needs to allow information displayed on the display module to be shown to the user through the window. Accordingly, the window may include a material having appropriate strength and transparency. The display module may be directly attached to a rear surface of the window. The display module may be directly attached to the window in various ways, and an adhesive may be most conveniently used for direct attachment.

The display 30 may include a touch sensor (not shown) for sensing a touch on the display 30 to receive a control command by a touch method. The content which is input in a touching manner may be a text or a numerical value, or a menu item to be indicated or designated in various modes. The touch sensor may be configured in the form of a film having a touch pattern to be located between the window and the display module, or may include a metal wire which is patterned directly on a rear surface of the window. Alternatively, the touch sensor may be integrally formed with the display module. For example, the touch sensor may be located on a substrate of the display module or may be provided inside the display module. As such, the display 30 may form a touch screen together with the touch sensor, and in this case, the touch screen may function as a user input unit. According to the complex configuration of the display 30, the display 30 is displayed as a single module or an assembly including a plurality of layers, that is, components.

The display 30 may be accommodated in the housing 10 as illustrated in such a manner that the display device 100 may have a compact structure. To accommodate the display 30 in the housing 10, the display 30 needs to be basically deformed. Accordingly, the display device 100 may use a flexible display as the display 30.

The display 30 may include a flexible display to be deformable by an external force. The deformation may be at least one of bending, curving, folding, twisting, and rolling of the display 30. A typical flexible display is manufactured on a thin flexible substrate to be bent, curved, folded, twisted, or rolled, such as paper, while maintaining the characteristics of the existing flat panel display described above, and thus may not easily break. The flexible display 30 may be combined with a touch sensor as described above to implement a flexible touch screen.

Due to this deformable property, as shown in (b) of FIG. 6, the display 30 may be rolled on the roller 20. The display 30 may be wound around the roller 20 or unwound from the roller 20 according to a rotation direction of the roller 20. The display 30 may be unwound from the roller 20 and project or roll out to the outside of the housing 10. On the contrary, the display 30 may be wound around the roller 20 to retract/roll in the housing 10. In detail, as shown in (b) of FIG. 6, when the roller 20 rotates in a clockwise direction R1, the display 30 may be unwound from the roller 20 and be expanded to the outside of the housing 10 through an opening 11 formed in the housing 10.

Therefore, as described above, a screen accommodated in the housing 300 in (a) of FIG. 3 may be extended to the outside of the housing 310 as shown in (b) of FIG. 3, and a screen 311 having a certain size may be formed. When the roller 20 further rotates in the clockwise direction R1, the display 30 may be further unwound from the roller 20. Therefore, as shown in (c) of FIG. 3, the screen may protrude to a larger size outside the housing 10, and may form a screen of a larger size. When the roller 20 rotates in the counterclockwise direction R1, the display 30 may be wound around the roller 20 and may be contracted into the housing 10 through the opening 11. Accordingly, as shown in (b) of FIG. 3, the screen 321 of (c) of FIG. 3 may be contracted to have a relatively smaller size inside the housing 310, thereby forming a smaller screen. When the roller 20 further rotates counterclockwise R2, the display 30 may be further wound around the roller 20. Therefore, as shown in (a) of FIG. 3, the screen may not protrude to the outside of the housing 300, and may be completely accommodated in the housing 300. As described above, the display device 100 may control expansion of the display 20 to a required size, thereby forming a screen of a desired size. When the display device 100 is not in use, the display 20 may be completely accommodated in the housing 10, and the display device 100 may have a compact structure because the display device 100 is expanded only in a required size. As a result, the size of the screen formed on the display 20 may vary according to winding and unwinding of the flexible display 20.

Although not shown, the display device 100 may include a deformation sensor for sensing deformation of the flexible display 30. The deformation sensor may be provided in the flexible display 30 or the housing 10 to detect information related to deformation of the flexible display 30. Here, the information related to the deformation may include a direction in which the flexible display 20 is deformed, a degree of deformation, a deformation position, a deformation time, and an acceleration in which the deformed flexible display 30 is restored, and may further include various information to be sensed by bending of the flexible display 30.

A front portion of the display 30, which is expanded from the display device 100, may be protected by the window, while a rear portion of the display 30 may be exposed. The display 30 includes sensitive electronic components and substrates, and thus the display 30 needs to be properly protected to prevent malfunction. Accordingly, as illustrated in (b) of FIG. 6, the display device 100 may include the cover 40 configured to cover the rear portion of the extended display 30.

The cover 40 may include a plurality of links connected to each other. The link may have a width corresponding to a width of the display 30, and the links connected to each other, that is, the cover 40, may form a single plate covering the rear portion of the display 30. Any one of the links is pivotable with respect to another adjacent link, and thus as shown in the drawing, the cover 40 may be wound around a first roller 41 and may be guided to a rear side of the display 30 by the second roller 42.

When the display 30 is expanded during an operation of the display device 100, the first roller 41 may rotate to unwind the cover 40. The unwound cover 40 is guided by the second roller 41 and is attached to the rear portion of the display 30. Accordingly, the cover 40 may be extended to the outside of the housing 10 together with the display 30 to protect the rear portion of the display 30.

When the display 30 is contracted, the first roller 41 may rotate in an opposite direction to separate the cover 40 from the display 30, and the separated cover 40 may be guided by the second roller 42 to be wound around the first roller 41. In the cover 40, the first roller 41 may be driven by the motor 21 together with the roller 20, and a separate motor for driving the first roller 41 may be installed in the housing 10.

The display 30 may be difficult to maintain an expanded state due to the flexibility thereof. Accordingly, the display device 100 may include the supporter 50 configured to support the extended display 30. The supporter 50 may be extended to the outside of the housing 10 through the opening 11 by the motor 51 and the auxiliary supporter 52 connected thereto. Accordingly, the supporter 50 may be extended to the outside of the housing 10 together with the display 30. Accordingly, the display 30 expanded by the supporter 50 may be stably supported to display content to the user.

Hereinafter, detailed embodiments of the display device described above with reference to FIGS. 1 to 6 will be described.

That is, the display device in which a size of an exposed display region is changed may change content output to an entire region of the display and content output to a partial region. In particular, in an actual product, the display device generally outputs a basic home screen only when the entire region of the display is exposed. The display device has a small physical size for providing content, and thus the display device generally provides only weather content, schedule content, voice recognition content, and the like in some regions, and currently, does not provide content such as video playback. In particular, when the display device exposes only a partial region of the display, most of the functions of the remote controller to be operated in the entire region may not be used.

However, when only a partial region of the display is exposed, there may be a need to use content such as a home screen or image reproduction. To this end, in the present disclosure, even when only a partial region of the display is exposed, an OSD menu output from the entire region may be output through scaling, descaling, cropping, and the like. Accordingly, the display device may use all control buttons of the remote controller even when only the partial region of the display is exposed.

Hereinafter, although the display device is described as determining a size of an exposed portion of the display device and determining content output to a display region, this operation may be controlled by each of the aforementioned controller and each module, needless to say. However, for convenience of description, the case in which the display device performs the operation will be described.

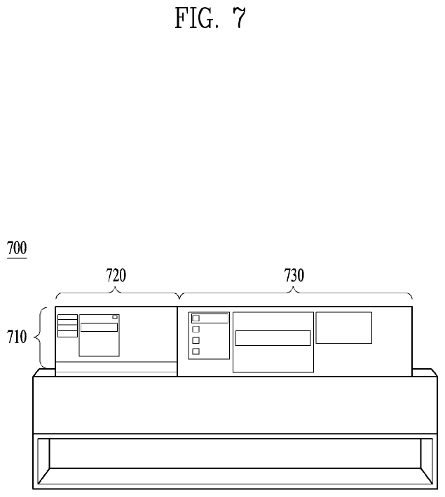

FIG. 7 is a diagram for explaining an embodiment in which a display of a display device outputs content in a partial region according to an embodiment of the present disclosure.

Referring to FIG. 7, a display device 700 may expose a partial region 710 of the display region. In this case, the display device 700 may have a default mode in which only the partial region 710 of the display is exposed to the outside of the housing.

In an embodiment of the present disclosure, the display device 700 may output content to a first region 720 of the partial region 710 in a state in which only the partial region 710 of the display region is exposed. Here, the output content may correspond to image content. For example, the display device 700 may output broadcast content corresponding to the above-described broadcast signal.

The display device 700 may receive a control signal while outputting content in the first region 720. Here, the control signal may correspond to a signal from the remote controller described above. For example, the display device 700 may receive a signal that allows a user to select a physical button of the remote controller.

Then, the display device 700 may output an OSD menu in at least one of the first region 720 and a second region 730. In this case, the first region 720 may be defined as an image region, and the second region 730 may be defined as an OSD region. Here, division of the first region 720 and the second region 730 may be determined when the display device 700 is released, or may be determined by user setting.

In this case, when the display device 700 outputs the OSD menu in the first region 720, the display device 700 may output the OSD menu and content together. That is, the OSD menu may be output by overlaying the content.

When the display device 700 outputs an OSD menu to both the first region 720 and the second region 730, the display device 700 may equally apply an input signal for the OSD menu to the first region 720 and the second region 730. In detail, although the display device 700 receives an input signal for the OSD menu displayed in the first region 720, the display device 700 may equally apply to the OSD menu output in the second region 730. When the display device 700 detects focus movement for the OSD menu displayed in the second region 730, the display device 700 may determine the focus movement of the OSD menu displayed in the first region 720. Accordingly, when the display device 700 receives the control signal while the OSD menu is being output, the display device 700 may scroll and output the OSD menu based on a moving path of the control signal. For example, when the display device 700 receives a control signal for the OSD menu displayed in the first region 720, the display device 700 may scroll and output the OSD menu displayed in the second region 730.

When the content and the OSD menu are simultaneously output to the first region 720, the display device 700 may scale the video signal and the OSD menu corresponding to the content based on a size of the partial region 710 of the display region.

For example, when the display device 700 outputs the OSD menu in the second region 730, a vertical size of the OSD menu output from the second region 730 may be the same as a vertical size of the OSD menu when the OSD menu is output on the entire region (not shown) of the display region, and a horizontal size of the OSD menu output from the second region 730 may be scaled or cropped to be the same as the horizontal size of the second region 730.

For another example, when the display device 700 outputs the OSD menu in the second region 730, the display device 700 may scale the size of the OSD menu output from the entire region (not shown) of the display region based on the horizontal size of the second region 730, and crop based on the vertical size of the second region 730. This will be described in detail below.

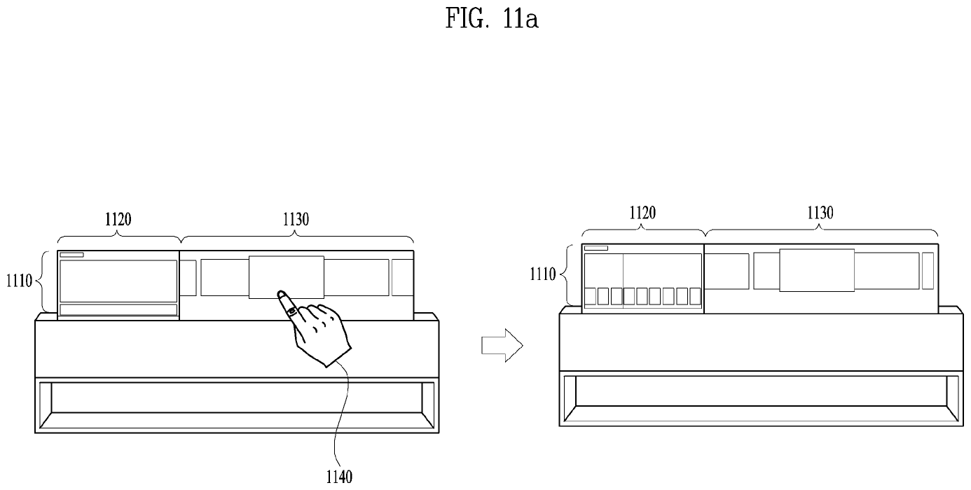

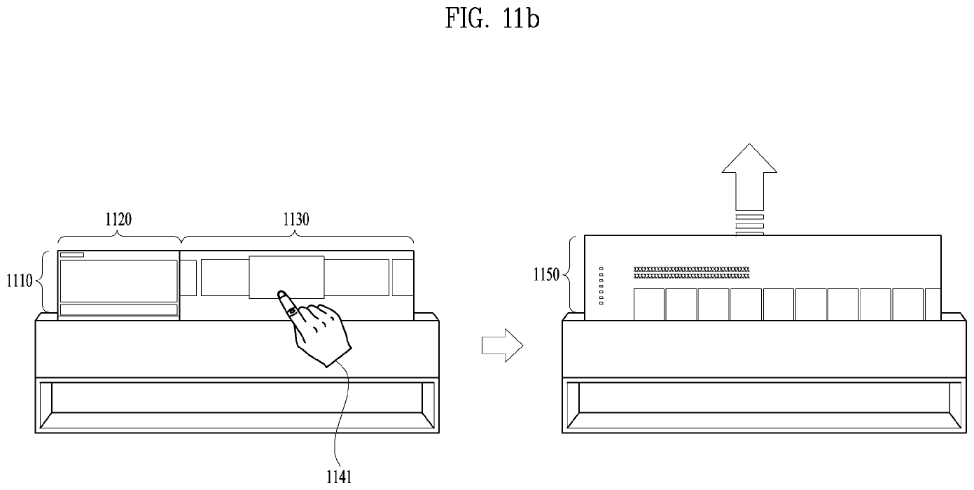

When the display device 700 receives an input signal for selecting a first menu from the OSD menu while the OSD menu is being output, the display device 700 may output content corresponding to the first menu in the first region 720. On the other hand, when the display device 700 receives an input signal for selecting the second menu from the OSD menu while the OSD menu is output, the display device 700 may control the motor to expose the entire region of the display region and output content corresponding to the second menu to the exposed entire region (not shown). This will be described in detail with reference to FIGS. 11A and 11B.

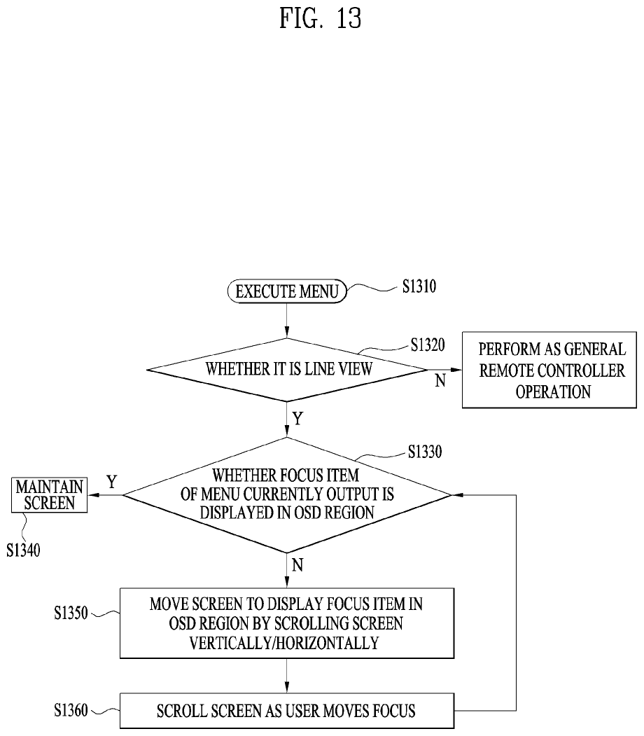

When the display device 700 recognizes a focus of a third menu in the OSD menu while the OSD menu is being output in the first region 720, the display device 700 may enlarge and output the third menu in the second region 730 based on the focus. This will be described in detail with reference to FIG. 13.

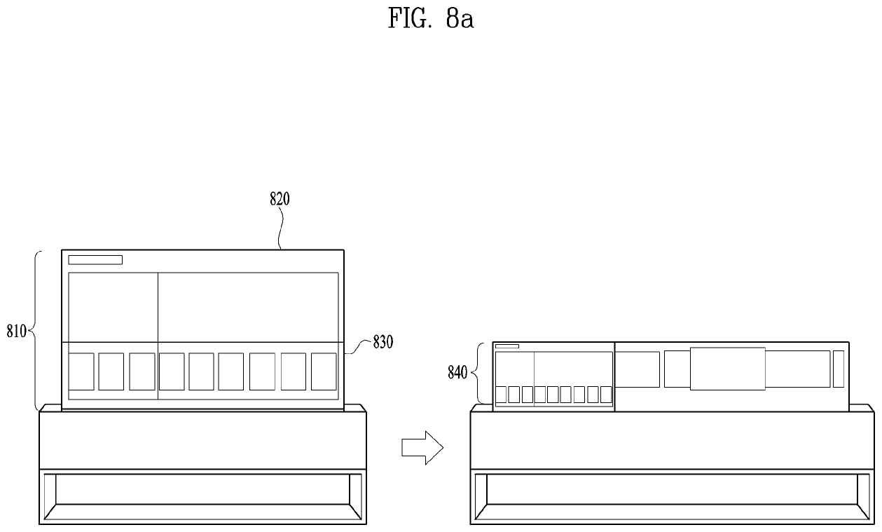

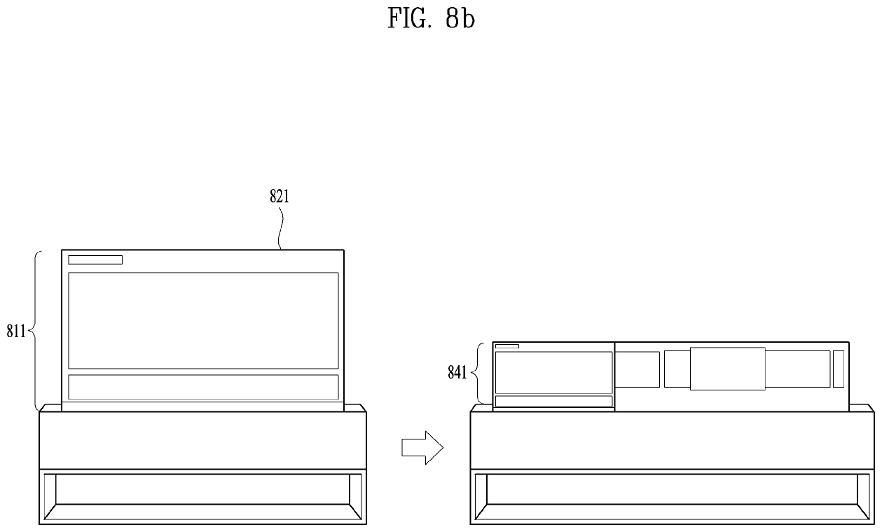

FIGS. 8A and 8B are diagrams for explaining an embodiment in which content output to an entire region of a display of a display device is output in a partial region according to an embodiment of the present disclosure.

FIG. 8A illustrates an embodiment of outputting content and an OSD menu together, and FIG. 8B illustrates an embodiment of outputting only content.

Referring to FIG. 8A, a left drawing of FIG. 8A illustrates a state in which an entire region 810 of the display of the display device is exposed. In this case, the display device may output an OSD menu 830 together with the content 820 in the entire region 810 of the display.

In an embodiment of the present disclosure, when receiving a control signal, the display device may control the motor to expose only a partial region 840 of the display region. Then, the display device may output the content 820 output from the entire region 810 and the OSD menu 830 in the first region of the partial region 840 of the display. In this case, the display device may scale the content 820 and the OSD menu 830 output from the entire region 810 of the display to ⅓ based on the size of the partial region 840 and output the same.

Referring to FIG. 8B, in a state in which an entire region 811 of the display is exposed, the display device may output content 821 to the entire region 811. Unlike FIG. 8A, in FIG. 8B, the display device may not output the OSD menu on the entire region 811. Then, when receiving a control signal, the display device may control the motor to expose only a partial region 841 of the display region, and may output the content 821 to a first region of the partial region 841. In this case, unlike FIG. 8A, the display device may scale only a video signal corresponding to the content 821 to ⅓ based on the size of the partial region 841 and output the same.

In the embodiment of FIGS. 8A and 8B, when the display device exposes the partial regions 840 and 841 based on the control signal, the display device outputs the contents 820 and 821 in the first region of the partial regions 840 and 841, but when a default mode of a turn-on state of the display device is a mode in which only the partial regions 840 and 841 are output, the display device may output the contents 820 and 821 to the first region of the partial regions 840 and 841 without a control signal.

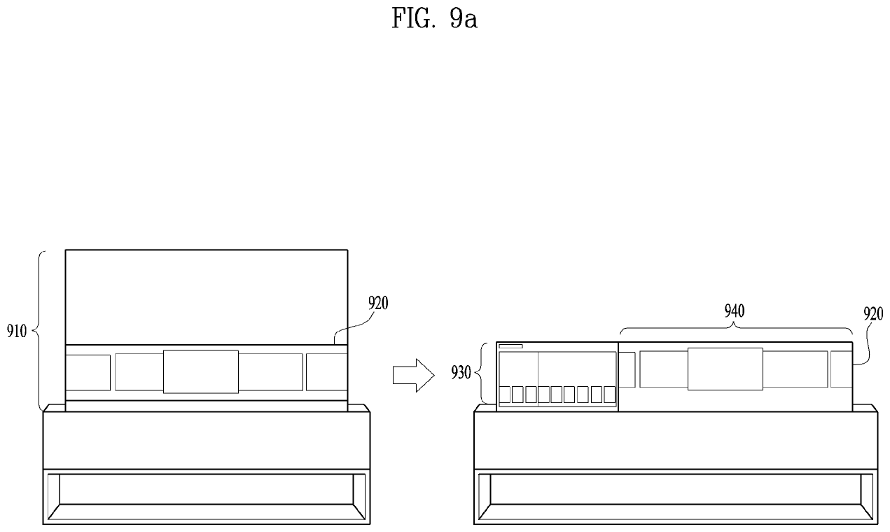

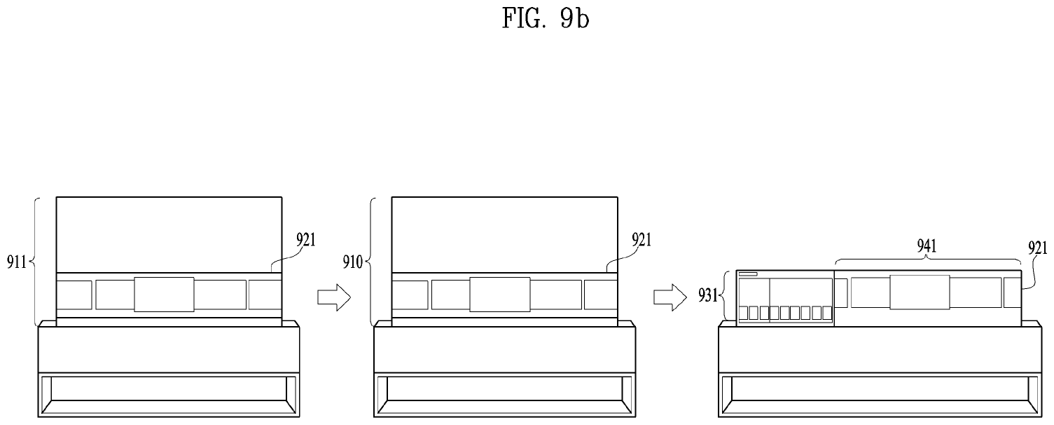

FIGS. 9A and 9B are diagrams for explaining an embodiment in which an OSD menu output from an entire region of a display of a display device is output in a partial region according to an embodiment of the present disclosure. In this case, a region to which the content of FIGS. 9A and 9B is output is described with reference to FIG. 8A, but the present disclosure is not limited thereto.

Referring to FIG. 9A, a left drawing of FIG. 9A illustrates a state in which an entire region 910 of the display of the display device is exposed. In this case, the display device may output an OSD menu 920 to the entire region 910 of the display. The display device may output an OSD menu together with content (not shown), but the embodiment of FIGS. 9A and 9B will be described based on the OSD menu.

In an embodiment of the present disclosure, the display device may crop a layer of the OSD menu 920 based on a vertical size of an OSD menu 920 that is currently output in the entire region 910 of the display. Then, when the display device switches to a mode in which only a partial region 930 of the display is exposed, the display device may crop a layer of the OSD menu 920 based on a horizontal size of a second region 940 of the partial region 930 of the cropped OSD menu 920.

On the other hand, referring to FIG. 9B, to output an OSD menu 921 to a second region 941 of the partial region 931, the display device may scale the OSD menu 921, which is currently output from an entire region 911 of the display, based on a horizontal size of the second region 941 of the partial region 931. Then, the display device may crop a vertical size of the OSD menu 921 based on a vertical size of the second region 941 of the partial region 931.

That is, the display device may output the OSD menu 921 in the second regions 940 and 941 of the partial regions 930 and 931 as the display device switches to the mode for exposing only the partial regions 930 and 931. In this case, to output an appropriate size of the OSD menu 921 in the second regions 940 and 941 of the partial regions 930 and 931, the display device may scale or crop the size of the OSD menu 921 output in the entire regions 910 and 911.

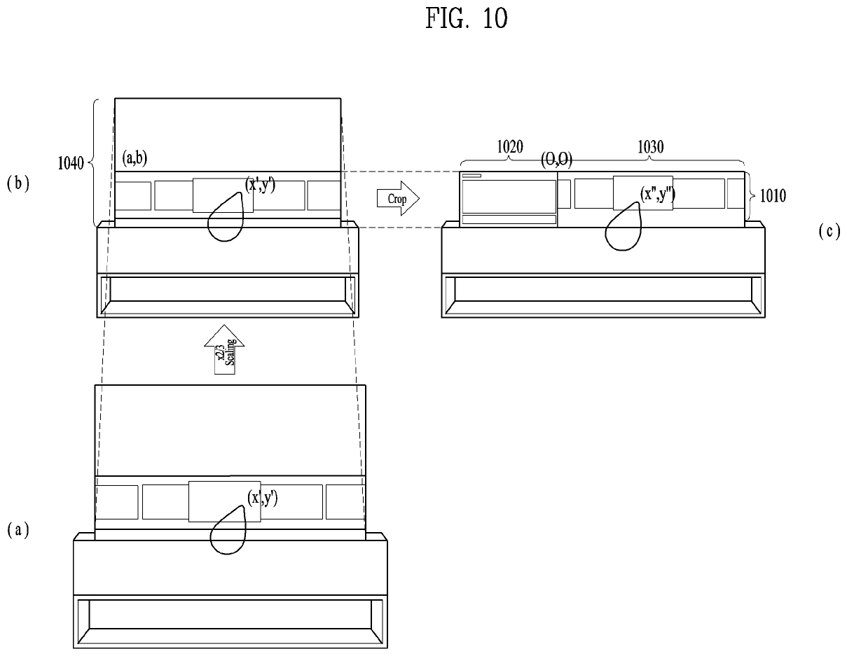

FIG. 10 is a diagram for explaining an embodiment of calculating coordinates when a display device selects an OSD menu according to an embodiment of the present disclosure.

As shown in FIGS. 7 to 9B, when the OSD menu is displayed on a partial region of the display device, the display device needs to recognize selection coordinates for a partial region as selection coordinates for an entire region when receiving the OSD menu from the user. This method will be described with reference to FIG. 10.

That is, an embodiment in which an OSD menu is output in a partial region of the display device corresponds to the drawing of (c) of FIG. 10, but corresponds to an embodiment, in which a portion in which an OSD menu is output, is scaled to ⅔ and output in (a) and (b) of FIG. 10 in which an OSD menu is output in an entire region of the display device (the embodiment of FIG. 9B). Thus, to extract accurate coordinates of a signal for selecting an OSD menu of a partial region, the display device may obtain coordinates in the entire region.

In detail, referring to (c) of FIG. 10, in a state in which only a partial region 1010 of a display is exposed, the display device may divide a first region 1020 for outputting content and a second region 1030 for outputting an OSD menu. In an embodiment of the present disclosure, the display device may set upper left coordinates of the second region 1030 from which the OSD menu is output to (0, 0), and may obtain coordinates (x″, y″) at which an input signal is received from a user from among output OSD menus.

Then, referring to (b) of FIG. 10, the OSD menu of (c) of FIG. 10 is cropped and output from the OSD menu in the entire region of (b) of FIG. 10, and thus it is possible to counter-calculate the obtained coordinates. In detail, the display device may set coordinates of left upper end in an entire region 1040 to (a, b) before the OSD menu is cropped. Accordingly, in the entire region 1040 of the display of (b) of FIG. 10, coordinates (x′, y′)=(x″, y″)+(a, b) of the input signal received from the user in the OSD menu may be obtained.

Similarly, referring to (a) of FIG. 10, the OSD menu of (b) of FIG. 10 is scaled to ⅔ of the OSD menu in the entire region of (a) of FIG. 10 and output. In detail, the display device may obtain coordinates (x, y)=(x′, y′)×⅔ for an input signal received from a user in the original OSD menu.

That is, when receiving a user input signal for selecting coordinates of x″, y″ from a remote controller, a controller of the display device may obtain coordinates of x, y with respect to the original OSD menu, and execute the OSD menu in which the actual x, y coordinates are selected using the above calculation method.

FIGS. 11A and 11B are diagrams for explaining an embodiment of selecting an OSD menu in a display device according to an embodiment of the present disclosure.

In an embodiment of the present disclosure, in a state in which only a partial region of a display is exposed to the outside of a housing, the display device may output content to a first region of a partial region and output an OSD menu in a second region of the partial region.

The display device may receive a signal for selecting an OSD menu that is currently output in the second region. In this case, FIG. 11A illustrates an embodiment in which content corresponding to the selected OSD menu is output in a first region, and FIG. 11B illustrates an embodiment in which content corresponding to the selected OSD menu is output in an entire region.

In detail, referring to a left drawing of FIG. 11A, the display device may expose only a partial region 1110 of the display to the outside of the housing, output content to a first region 1120, and output an OSD menu in the second region 1130.

In an embodiment of the present disclosure, while the OSD menu is currently output in the second region 1130, the display device may receive a first input signal 1140 for selecting a first menu from among the OSD menus. In this case, when the first input signal 1140 corresponds to a signal received from the remote controller or the display is a touch screen, the first input signal 1140 may correspond to a signal that the user directly touches the display or a voice input signal recognized by the user.

Referring to a right drawing of FIG. 11A, the display device may output content corresponding to a first menu in the first region 1120 of the partial region 1110 of the display as the first input signal 1140 is received. Accordingly, the user can view small content corresponding to the first menu in the first region 1120 and continue to use the OSD menu displayed in the second region 1130.

A left drawing of FIG. 11B illustrates the same embodiment as the left drawing of FIG. 11A. However, unlike FIG. 11A, while the OSD menu is currently output in the second region 1130, the display device may receive a second input signal 1141 for selecting a second menu from among the OSD menus. As described above, the second input signal 1141 may correspond to a signal received from the remote controller.

Then, referring to a right drawing of FIG. 11B, the display device may control a motor to expose an entire region 1150 of the display region as the second input signal 1141 is received. The display device may output content corresponding to the second menu in the entire region 1150. In this case, the display device may output the content corresponding to the second menu after the entire region 1150 of the display is exposed. Even before the entire region 1150 of the display is exposed, the display device may output content corresponding to the second menu while the display region is expanded from the partial region 1110 to the entire region 1150.

In FIGS. 11A and 11B, signals received by the display device are distinguished from each other by the first input signal 1140 and the second input signal 1141, but this is merely exemplary. That is, the display device may output content in the first region 1120 of the partial region 1110 or output content in the entire region 1150 based on a predefined setting or on the characteristics of the input signals 1140 and 1141. For example, the first input signal 1140 may correspond to a signal pressing a playback button of the remote controller once, and the second input signal 1141 may correspond to a signal pressing a playback button of the remote controller twice.

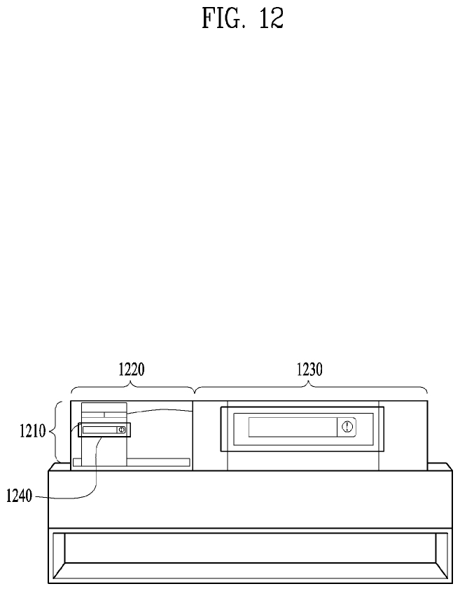

FIG. 12 is a diagram for explaining an embodiment of controlling an OSD menu in a display device according to an embodiment of the present disclosure.

In a state in which only a partial region 1210 of the display is exposed to the outside of the housing, the display device may output the content and the OSD menu together in the first region 1220, and may output only the OSD menu in the second region 1230. That is, this may correspond to the embodiment of FIG. 8A.

In an embodiment of the present disclosure, the display device may recognize a focus of a first point 1240 of the OSD menu while the OSD menu is currently output in the first region 1220. Here, the first point 1240 may correspond to one point or may correspond to a region. Recognizing the focus may correspond to a user input signal being recognized at the first point 1240 of the OSD menu as described above with reference to FIG. 10.

Accordingly, the display device may enlarge and output a menu corresponding to the first point in the second region 1230 based on the focus.

That is, when the display device exposes only the partial region 1210 of the display to the outside of the housing, a region for outputting the content and the OSD menu may be significantly limited as compared to the entire region. When the display device outputs the content and the OSD menu together in the first region 1220 of the partial region 1210, the output OSD menu may be output significantly less, and optional letters included in the OSD menu may be output smaller. To compensate for this point, when the focus of the OSD menu currently output in the first region 1220 is recognized, the display device may enlarge and output only the region in which the focus is recognized in the second region 1230.

FIG. 13 is a flowchart illustrating a method of controlling a display device according to an embodiment of the present disclosure.

In operation S1310, the display device may receive an input signal for executing an OSD menu. Here, the input signal may correspond to a signal by which the user controls the display device using the remote controller.

In operation S1320, the display device may determine whether it is a line view. In more detail, the display device may determine a degree of exposure of the display region outside the housing. That is, the display device may determine whether the display region exposed to the outside of the housing is a partial region (line view) or an entire region. When the entire region of the display region is exposed outside the housing, the display device may determine that the entire region of the display region is a full view rather than a line view, and may perform a general operation. However, when only a partial region of the display region is a line view exposed outside the housing, the display device may operate according to an embodiment of the present disclosure.

In operation S1330, the display device may determine whether a focus item of the OSD menu currently output is displayed in the OSD region. In detail, the display device may divide a partial region of the display into a first region and a second region to output content to the first region and output an OSD menu in the second region. In this case, the first region may be defined as a content region and the second region as an OSD region.

In an embodiment of the present disclosure, when a focus item of the OSD menu currently output is displayed in the OSD region, the display device may maintain a current screen in operation S1340. In this case, the display device may recognize an item currently focused through FIG. 10.

On the other hand, when the focus item of the OSD menu currently output is not displayed on the OSD region, in operation S1350, the screen may be moved to be displayed on the OSD region by scrolling the screen horizontally or vertically.

In operation S1360, the display device scrolls and outputs the screen in real time in the OSD region to display the focus item in the OSD region based on that the user moves the remote controller to move the focus.

The embodiments described above with reference to FIGS. 1 to 12 may be implemented as a method of controlling the display device as shown in FIG. 13. That is, although FIGS. 1 to 12 describe that the display device (device) is performed for convenience of description, all embodiments may be implemented by a control method of the display device.

Various embodiments may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet). The processor may include the controller 180 of the mobile terminal. The foregoing embodiments are merely exemplary and are not to be considered as limiting the present disclosure. The present teachings can be readily applied to other types of methods and apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

### Mode

Various embodiments of the present disclosure have been described in “Best Mode” which is the previous list, and it needs to appreciate by those skilled in the art to combine the embodiments described in the two or more drawings as needed to belong to the scope of the present disclosure.

### INDUSTRIAL APPLICABILITY

The present disclosure is applicable to a display device of various form factors such as a rollable display device, and thus industrially applicable.

What is claimed is:

1. A method of controlling a display device in which a size of an exposed display region is changed, the method comprising:
outputting content in a first region of a partial region of the display region in a state in which only the partial region of the display region is exposed;
receiving a first control signal in a state in which content is output in the first region; and
outputting an on screen display (OSD) menu in at least one of the first region and a second region of the partial region.

2. The method of claim 1, further comprising, based on the OSD menu being output in the first region, outputting the OSD menu and the content together.

3. The method of claim 1, further comprising, based on the OSD menu being output in both the first region and the second region, equally applying an input signal for the OSD menu to the first region and the second region.

4. The method of claim 1, further comprising, based on the content and the OSD menu being simultaneously output in the first region, scaling an image signal corresponding to the content and the OSD menu based on a size of the partial region of the display region.

5. The method of claim 1, wherein, based on the OSD menu being output in the second region, a vertical size of the OSD menu output in the second region is equal to a vertical size at a time of outputting the OSD menu in an entire region of the display region, and a horizontal size of the OSD menu output in the second region is equal to a vertical size of the second region.

6. The method of claim 1, further comprising, based on the OSD menu being output in the second region, descaling a size of the OSD menu output in an entire region of the display region based on a horizontal size of the second region, cropping the size of the OSD menu based on a vertical size of the second region, and outputting the OSD menu in the second region.

7. The method of claim 1, further comprising, based on receiving of a second control signal in a state in which the OSD menu is currently output, scrolling and outputting the OSD menu based on a moving path of the second control signal.

8. The method of claim 1, further comprising, based on receiving of an input signal of selecting a first menu of the OSD menu in a state in which the OSD menu is currently output, outputting content corresponding to the first menu in the first region.

9. The method of claim 1, further comprising:
based on receiving of an input signal of selecting a second menu of the OSD menu in a state in which the OSD menu is currently output, controlling a motor to expose an entire region of the display region; and
outputting content corresponding to the second menu in the entire region.

10. The method of claim 1, further comprising:
in a state in which the OSD menu is currently output in the first region, recognizing a focus for a third menu of the OSD menu; and
enlarging and outputting the third menu in the second region based on the focus.

11. The method of claim 1, wherein content displayed in the first region is content displayed immediately before the display device is turned off.

12. A display device comprising:
a display including a display region in which content is output;
a memory configured to store at least one data;
a motor controlled to expose a partial region of the display region; and
a controller configured to control the display, the memory, and the motor,
wherein the controller is configured to output content in a first region of the partial region in a state in which only the partial region of the display region is exposed,
a first control signal is received in a state in which content is output in the first region, and
an on screen display (OSD) menu is output in at least one of the first region and a second region of the partial region.

13. The display device of claim 12, wherein, based on the OSD menu being output in both the first region and the second region, the controller is configured to equally apply an input signal for the OSD menu to the first region and the second region.

14. The display device of claim 12, wherein, based on the content and the OSD menu being simultaneously output in the first region, the controller is configured to scale an image signal corresponding to the content and the OSD menu based on a size of the partial region of the display region.

15. The display device of claim 12, wherein, based on the OSD menu being output in the second region, a vertical size of the OSD menu output in the second region is equal to a vertical size at a time of outputting the OSD menu in an entire region of the display region, and a horizontal size of the OSD menu output in the second region is equal to a vertical size of the second region.

16. The display device of claim 12, wherein, based on the OSD menu being output in the second region, the controller is configured to descale a size of the OSD menu output in an entire region of the display region based on a horizontal size of the second region, crop the size of the OSD menu based on a vertical size of the second region, and output the OSD menu in the second region.

17. The display device of claim 12, wherein, based on receiving of a second control signal in a state in which the OSD menu is currently output, the controller is configured to scroll and output the OSD menu based on a moving path of the second control signal.

18. The display device of claim 12, wherein, based on receiving of an input signal of selecting a first menu of the OSD menu in a state in which the OSD menu is currently output, the controller is configured to output content corresponding to the first menu in the first region.

19. The display device of claim 12, wherein, based on receiving of an input signal of selecting a second menu of the OSD menu in a state in which the OSD menu is currently output, the controller is configured to control a motor to expose an entire region of the display region and output content corresponding to the second menu in the entire region.

20. The display device of claim 12, wherein, in a state in which the OSD menu is currently output in the first region, the controller is configured to recognize a focus for a third menu of the OSD menu and enlarge and output the third menu in the second region based on the focus.
